(19) United States
(12) Patent Application Publication
(10) Pub. No.: US 2020/0180692 A1
(43) Pub. Date: Jun. 11, 2020

(54) SYSTEM AND METHOD TO MODEL STEERING CHARACTERISTICS

(71) Applicant: GM GLOBAL TECHNOLOGY OPERATIONS LLC, Detroit, MI (US)

(72) Inventors: Apral S. Hara, Lasalle (CA); Allan K. Lewis, Windsor (CA); Mohammad Naserian, Windsor (CA)

(21) Appl. No.: 16/213,108

(22) Filed: Dec. 7, 2018

(51) Int. Cl. B62D 15/02; G06F 16/9537

(52) U.S. Cl. CPC B62D 15/021; G06F 16/9537

(57) ABSTRACT

An exemplary method for modeling steering characteristics of a vehicle includes receiving first sensor data corresponding to a steering wheel angle, receiving second sensor data corresponding to image data of an external environment of the vehicle, generating a vehicle movement model from the first and second sensor data, determining a lateral vehicle velocity and a longitudinal vehicle velocity along a vehicle path of travel, defining a road wheel angle based at least in part on the lateral and longitudinal velocities of the vehicle, and determining a road wheel to steering wheel angle ratio using a plurality of polynomial curves to approximate the road wheel to steering wheel angle ratio.

### INTRODUCTION

The present invention relates generally to the field of vehicles and, more specifically, to model steering characteristics using vision-based object detection and tracking.

Autonomous driving systems typically allow some or all driving functions to be taken over by the vehicle and its onboard computers. Examples of some components of autonomous driving systems may include low speed automated vehicle maneuvers such as trailer hitching, trailer backup, and parking that aim to provide a wide range of assistance in keeping the vehicle within a prescribed boundary or area under a number of possible and varied circumstances.

However, steering system model accuracy when the vehicle is moving at a low speed is different from steering system model accuracy when the vehicle is moving at a higher speed, particularly for a towing vehicle.

### SUMMARY

Embodiments according to the present disclosure provide a number of advantages. For example, embodiments according to the present disclosure enable real-time modeling of steering characteristics of a towing vehicle using vision-based object detection and tracking as well as vehicle operation characteristics including but not limited to tire pressure, vehicle age, vehicle load, vehicle type/configuration, etc.

In one aspect, a method for modeling steering characteristics of a vehicle includes the steps of receiving, from at least one vehicle sensor, first sensor data corresponding to a steering wheel angle, receiving, from at least one vehicle sensor, second sensor data corresponding to image data of an external environment of the vehicle, generating, by one or more data processors, a vehicle movement model from the first and second sensor data, determining, by the one or more data processors, a lateral vehicle velocity and a longitudinal vehicle velocity along a vehicle path of travel, defining, by the one or more data processors, a road wheel angle based at least in part on the lateral and longitudinal velocities of the vehicle, and determining, by the one or more data processors, a road wheel to steering wheel angle ratio using a plurality of polynomial curves to approximate the road wheel to steering wheel angle ratio.

In some aspects, the second sensor data comprises first image data received from a front view image sensor, second image data received from a left side view image sensor, third image data received from a right side view image sensor, and fourth image data received from a rear view sensor.

In some aspects, the second sensor data comprises detected locations of one or more road features and the database data comprises known locations of the one or more road features.

In some aspects, generating the vehicle movement model comprises comparing the second sensor data with database data to determine a position of the vehicle relative to the one or more road features.

In some aspects, generating the vehicle movement model comprises correlating the detected locations of the one or more road features with the known locations of the one or more road features to determine the longitudinal and lateral distance traveled by the vehicle and generating a position change map of the vehicle.

In some aspects, determining the lateral vehicle velocity and the longitudinal vehicle velocity along a vehicle path of travel comprises calculating the lateral vehicle velocity and the longitudinal vehicle velocity from the longitudinal and lateral distance traveled by the vehicle generated by the vehicle movement model over a predetermined elapsed time.

In some aspects, defining the road wheel angle based at least in part on the lateral and longitudinal velocities of the vehicle comprises receiving the first sensor data at a first data recording frequency and receiving the second sensor data at the first data recording frequency and calculating the road wheel angle using the equation

$${δ}_{f} = {tan}^{- 1} ( \frac{{V}_{y} \cdot L}{{V}_{x} \cdot b} )$$

where the road wheel angle is expressed as δ_{f}, L is a wheel base of the vehicle, b is a distance from a center of gravity of the vehicle to a rear tire contact point, Vₓ is the longitudinal velocity of the vehicle, and V_{y} is the lateral velocity of the vehicle.

In another aspect, a method for modeling steering characteristics of a vehicle includes the steps of determining, by one or more data processors, whether a first condition is satisfied, receiving, by the one or more data processors, first sensor data corresponding to a steering wheel angle from at least one vehicle sensor, receiving, by the one or more data processors, second sensor data corresponding to image data of an external environment of the vehicle from at least one vehicle sensor, if the first condition is satisfied, determining, by the one or more data processors, whether a second condition is satisfied, if the second condition is satisfied, generating, by the one or more data processors, a vehicle movement model from the first and second sensor data, determining, by the one or more data processors, a lateral vehicle velocity and a longitudinal vehicle velocity along a vehicle path of travel, defining, by the one or more data processors, a road wheel angle based at least in part on the lateral and longitudinal velocities of the vehicle, and determining, by the one or more data processors, a road wheel to steering wheel angle ratio using a plurality of polynomial curves to approximate the road wheel to steering wheel angle ratio.

In some aspects, the first condition is whether the vehicle is moving.

In some aspects, the second condition is whether a motion tracking feature of the vehicle is active.

In some aspects, the second sensor data comprises detected locations of one or more road features and the database data comprises known locations of the one or more road features.

In some aspects, generating the vehicle movement model comprises comparing the second sensor data with database data to determine a position of the vehicle relative to the one or more road features.

In some aspects, generating the vehicle movement model comprises correlating the detected locations of the one or more road features with the known locations of the one or more road features to determine the longitudinal and lateral distance traveled by the vehicle and generating a position change map of the vehicle.

In some aspects, determining the lateral vehicle velocity and the longitudinal vehicle velocity along a vehicle path of travel comprises calculating the lateral vehicle velocity and the longitudinal vehicle velocity from the longitudinal and lateral distance traveled by the vehicle generated by the vehicle movement model over a predetermined elapsed time.

In some aspects, defining the road wheel angle based at least in part on the lateral and longitudinal velocities of the vehicle comprises receiving the first sensor data at a first data recording frequency and receiving the second sensor data at the first data recording frequency and calculating the road wheel angle using the equation

$${δ}_{f} = {tan}^{- 1} ( \frac{{V}_{y} \cdot L}{{V}_{x} \cdot b} )$$

where the road wheel angle is expressed as δ_{f}, L is a wheel base of the vehicle, b is a distance from a center of gravity of the vehicle to a rear tire contact point, Vₓ is the longitudinal velocity of the vehicle, and V_{y} is the lateral velocity of the vehicle.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment.

FIG. 2 is a schematic block diagram of a steering control system, according to an embodiment.

FIG. 3 is a flow chart of a method for modeling steering characteristics, according to an embodiment.

FIG. 4 is a graphical representation of a vehicle's intended path of travel, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to Which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Autonomous, semi-autonomous, automated, or automatic steering control features (e.g., automated parking, automated trailering maneuvers, etc.) may maintain or control the position of a vehicle with respect to road markings, such as a lane on the road, or parking markers, with reduced driver input (e.g., movement of a steering wheel).

Motion Tracking Calibration (MTC), performed by a vehicle controller, monitors surface markers such as tar lines, road cracks, parking lines, etc. and compares these images with other images captured by one or more sensors of the vehicle to determine the lateral and longitudinal movement of the vehicle. The lateral and longitudinal movement information is used to generate a position change map. The position change map is used to determine the road wheel angle. The road wheel angle is mapped to data received from the steering wheel angle sensor to create a road wheel to steering wheel angle map. The improved road wheel to steering wheel angle map improves steering accuracy, in particular for vehicles performing low speed automated maneuvers such as, for example, a towing operation or precise parking.

In some embodiments, a vehicle steering control system, or another onboard system in the vehicle, may measure, estimate, or evaluate, using sensor(s) associated with the vehicle, vehicle steering measurements or vehicle steering conditions such as the steering wheel angle, and environmental conditions such as the location of road markings with respect to the vehicle. The vehicle steering measurements or environmental conditions may be measured, estimated, or evaluated at predetermined intervals, in some examples, every 5-100 milliseconds, e.g., every 10 milliseconds, while the vehicle is in motion.

The vehicle steering control system may include other systems that measure steering torque, acceleration, lateral acceleration, longitudinal acceleration, speed, yaw rate, the position of the vehicle relative to environmental features such as road markings, etc. and/or other vehicle dynamics or steering measurements while the steering control system is activated. In some embodiments, these measurements may be compiled continuously while the vehicle is in motion.

In some embodiments, the vehicle steering control system, or a component thereof, may determine, based on the measured vehicle steering measurements (e.g., steering torque, steering angle), and/or other information (e.g., speed, acceleration, heading, yaw rate, other driver input, sensor images, and other information known in the art) of a vehicle, a control input command to be sent to one or more actuators to control vehicle steering.

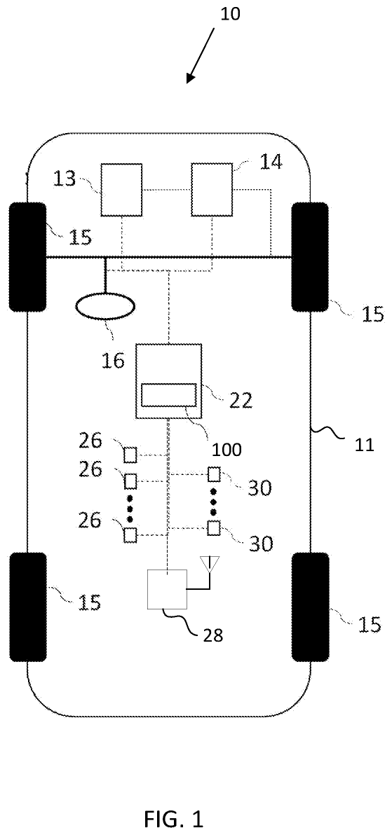

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

With further reference to FIG. 1, the controller 22 includes a vehicle steering control system 100. The vehicle steering control system 100 also interfaces with a plurality of sensors 26 of the vehicle 10. The sensors 26 are configured to measure and capture data on one or more vehicle characteristics, including but not limited to vehicle speed, vehicle heading, tire pressure, lateral acceleration, longitudinal acceleration, yaw rate, steering wheel angle, and environmental conditions such as images of road markings, etc. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking or other aspects of the vehicle.

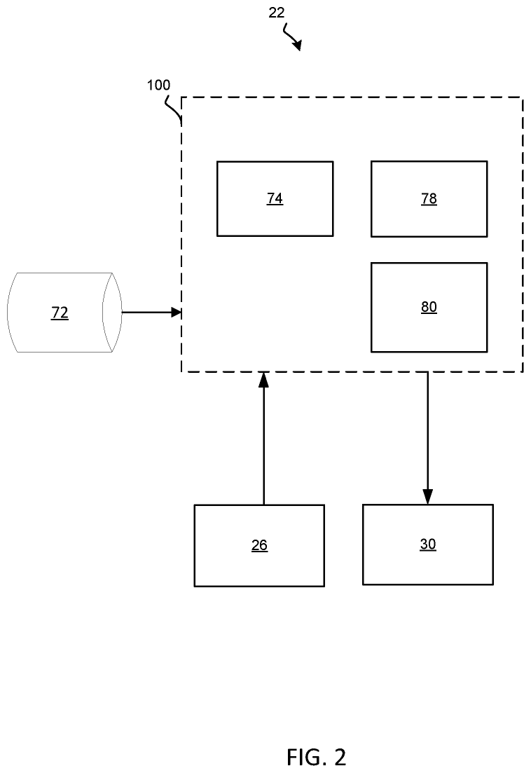

FIG. 2 is a schematic illustration of the vehicle steering control system 100. The vehicle steering control system 100 may operate in conjunction with or separate from one or more automatic vehicle control systems or autonomous driving applications. One or a plurality of vehicle automated steering system(s) may be component(s) of the system 100, or the vehicle automated steering system(s) may be separate from the system 100. The vehicle steering control system 100 may be incorporated within the controller 22 or within another controller of the vehicle 10.

The vehicle steering control system 100 includes a plurality of modules to receive and process data received from one or more of the sensors 26. In some embodiments, the vehicle steering control system 100 also generates a control signal that may be transmitted directly or via the controller 22 and an automatic vehicle control system or autonomous driving application to one or more of the actuators 30 to control vehicle steering.

In some embodiments, the vehicle steering control system 100 includes a sensor fusion module 74, a modeling module 76, and a vehicle control module 80. As can be appreciated, in various embodiments, the instructions may be organized into any number of modules (e.g., combined, further partitioned, etc.) as the disclosure is not limited to the present examples.

In various embodiments, the sensor fusion module 74 synthesizes and processes sensor data received from one or more sensors 26 and predicts the presence, location, classification, and/or path of objects and features of the environment of the vehicle 10. In various embodiments, the sensor fusion module 74 can incorporate information from multiple sensors, including but not limited to cameras, lidars, radars, and/or any number of other types of sensors. Additionally, the sensor fusion module 74 receives sensor data regarding vehicle operating conditions, including, for example and without limitation, steering wheel angle, vehicle heading, vehicle speed, lateral acceleration, longitudinal acceleration, yaw rate, etc.

In some embodiments, lateral and longitudinal movements of the vehicle 10 are used to determine the road wheel angle and map the road wheel angle to the steering wheel angle to create an improved road wheel to steering wheel angle map. In some embodiments, the modeling module 76 compares image data received from one or more sensors 26 to map data received from a map database 72. In some embodiments, the map database 72 is stored onboard the vehicle 10 as a component of the controller 22 or is remotely accessed by the controller 22 via a wired or wireless connection. The image data comparison is used by the controller 22 to generate a vehicle movement model, as discussed in greater detail herein.

In some embodiments, the modeling module 76 uses the processed and synthesized sensor data from the sensor fusion module 74, including the image data comparison and the vehicle movement model that includes vehicle lateral and longitudinal movement data, to build multiple, focused polynomial equations to model steering system dynamics. These equations are an improved model of steering system dynamics based on the characterization of vehicle movements acquired from location tracking data of remote vision system identifiers. In various embodiments, the modeling module 76 models the entire steering angle range and regularly updates the steering angle map to account for noise factors (such as, for example and without limitation, tire pressure, etc.) that could alter the steering angle to road wheel angle ratio. In some embodiments, the curve fit polynomial equations are applied to the steering ratio data over smaller steering angle segments to achieve an improved fit. Rather than using a single curve to map the data, multiple linear polynomial equations are used, which results in a steering ratio curve that is more robust and better fits the steering ratio data.

In various embodiments, the vehicle control module 80 generates control signals for controlling the vehicle 10 according to the determined steering ratio. The control signals are transmitted to one or more actuators 30 of the vehicle 10.

In various embodiments, the controller 22 implements machine learning techniques to assist the functionality of the controller 22, such as feature detection/classification, obstruction mitigation, route traversal, mapping, sensor integration, ground-truth determination, and the like.

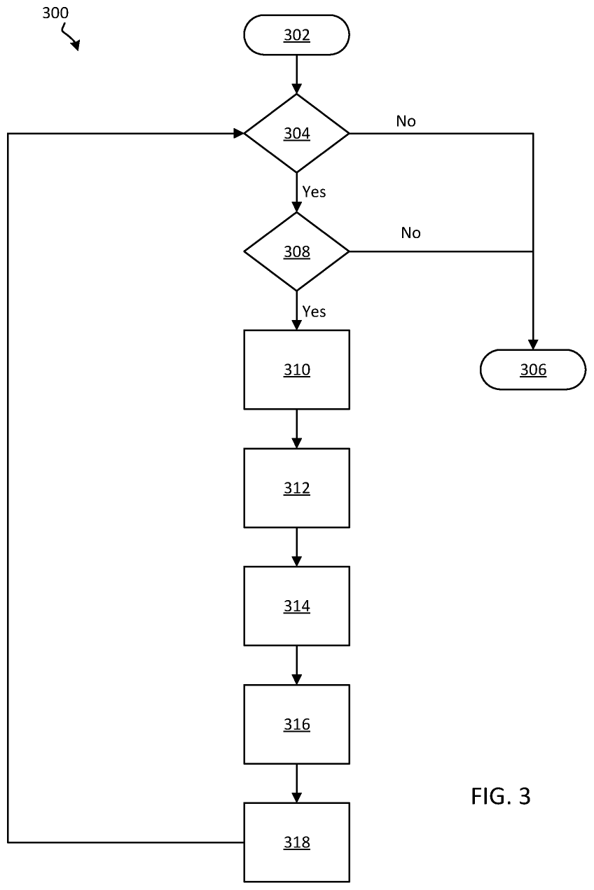

FIG. 3 illustrates a method 300 to model large angle steering characteristics, according to an embodiment. The method 300 can be utilized in connection with the steering system 16 and sensors 26 of the vehicle 10. The method 300 can be utilized in connection with various modules of the controller 22 as discussed herein, or by other systems associated with or separate from the vehicle, in accordance with exemplary embodiments. The order of operation of the method 300 is not limited to the sequential execution as illustrated in FIG. 3, but may be performed in one or more varying orders, or steps may be performed simultaneously, as applicable in accordance with the present disclosure.

The method 300 begins at 302 and proceeds to 304. At 304, the controller 22 determines whether a first condition is satisfied. In some embodiments, the first condition is whether the vehicle is moving. If the first condition is not satisfied, that is, the vehicle is not moving, the method 300 proceeds to 306 and ends.

However, if the first condition is satisfied, that is, the vehicle is moving, the method 300 proceeds to 308. At 308, the controller 22 determines whether a second condition is satisfied. In some embodiments, the second condition is whether a motion tracking function of the vehicle 10 is active. In some embodiments, the motion tracking function is implemented by the controller 22 as one aspect of the synthesis and processing of the sensor data performed by the sensor fusion module 74. In various embodiments, the motion tracking function of the sensor fusion module 74 includes video processing functions to analyze and interpret the image data received from one or more of the sensors 26 to determine the vehicle's position relative to environmental features, such as road markings, etc.

If the second condition is not satisfied, that is, the motion tracking function is not active, the method 300 proceeds to 306 and ends.

However, if the second condition is satisfied, that is, the motion tracking function is active, the method 300 proceeds to 310. At 310, the controller 22 receives sensor data from one or more of the sensors 26 regarding vehicle operating and environmental conditions including, for example and without limitation, steering wheel angle data, yaw rate data, and image data of the environment surrounding the vehicle 10. In various embodiments, the sensor data is received and processed by the sensor fusion module 74.

Next, at 312, the controller 22 generates a vehicle movement model. The vehicle movement model captures the steering system dynamics of the vehicle 10. In some embodiments, the vehicle movement model is calculated by the modeling module 76 using the data acquired from the sensors 26 and processed by the sensor fusion module 74. The controller 22 compares the captured image data to data received from a database, such as the database 72 shown in FIG. 2. The image data comparison is used by the controller 22 to generate the vehicle movement model which correlates the location of detected road markers with the known location of the road markers to determine the longitudinal and lateral distance traveled by the vehicle 10. In some embodiments, the image data from sensors 26 positioned at various locations around the vehicle 10 (front, rear, left side, right side, roof, for example and without limitation) are analyzed to correlate recognized features, such as road markings, between the images captured by the various sensors 26 to determine longitudinal and lateral vehicle motion and distance traveled relative to the recognized features.

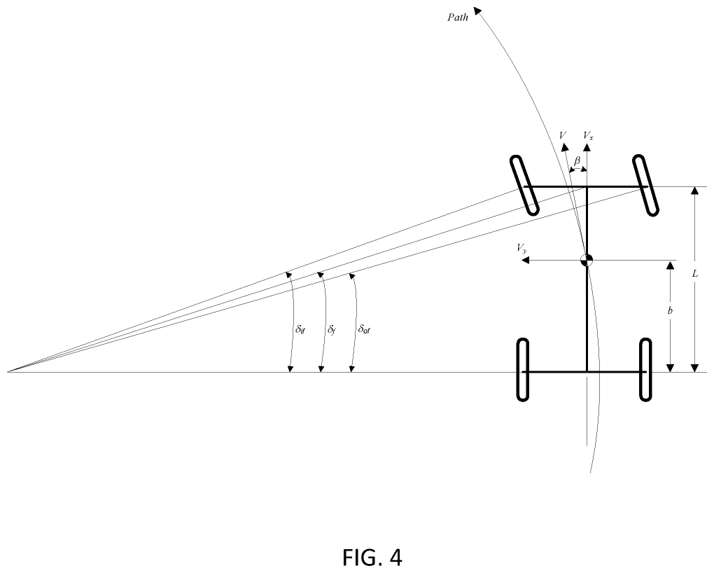

The method 300 then proceeds to 314. At 314, the controller 22 calculates the velocity of the vehicle 10 along the lateral and longitudinal axes from the lateral and longitudinal distances traveled over a predetermined elapsed time. FIG. 5 schematically illustrates the vehicle 10 traveling along a vehicle path. The velocities, indicated by Vₓ and V_{y} in FIG. 4, are components of the overall vehicle velocity V tangent to the vehicle's path of travel.

In FIG. 4, the references are defined as follows:

Vₓ is the vehicle velocity component along the longitudinal or x axis of the vehicle passing through the center of gravity or CG of the vehicle;

V_{y} is the vehicle velocity component along the lateral or y axis of the vehicle passing through the CG of the vehicle;

V is the vehicle velocity tangent to the vehicle path; and

b is the distance from the CG of the vehicle to the rear tire contact point.

Next, at 316, the controller 22 calculates the road wheel angle based on the relative motion of the vehicle 10 with respect to the change in steering wheel angle. This calculation is performed, in some embodiments, by the modeling module 76. The steering wheel angle data received from the sensors 26 is recorded by the controller 22 for each image captured by one of the sensors 26. That is, in some embodiments, the data recording frequency equals the image capture rate. The controller 22 uses the vehicle lateral velocity V_{y} and the vehicle longitudinal velocity Vₓ along with the vehicle wheel base L and the distance from the center of gravity of the vehicle 10 to the rear tire contact point along the x axis (indicated by b in FIG. 4) to determine the front road wheel angle δ_{f} in radians. The calculation may be expressed as:

$${δ}_{f} = {tan}^{- 1} ( \frac{{V}_{y} \cdot L}{{V}_{x} \cdot b} ) \qquad Equation 1$$

The method 300 then proceeds to 318. At 318, the modeling module 76 of the controller 22 generates the road wheel to steering wheel angle map using multiple, focused polynomial equations to model the steering system dynamics expressed in the position change map generated from the characterization of vehicle movements determined from the image comparison data. At each time interval at which sensor data is recorded, the road wheel angle is proportional to the steering wheel angle. Using smaller steering angle segments results in an improved mapping.

From 318, the method 300 returns to 304 and proceeds as discussed herein.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for modeling steering characteristics of a vehicle, comprising:
receiving, from at least one vehicle sensor, first sensor data corresponding to a steering wheel angle;
receiving, from at least one vehicle sensor, second sensor data corresponding to image data of an external environment of the vehicle;
generating, by one or more data processors, a vehicle movement model from the first and second sensor data;
determining, by the one or more data processors, a lateral vehicle velocity and a longitudinal vehicle velocity along a vehicle path of travel;
defining, by the one or more data processors, a road wheel angle based at least in part on the lateral and longitudinal velocities of the vehicle; and
determining, by the one or more data processors, a road wheel to steering wheel angle ratio using a plurality of polynomial curves to approximate the road wheel to steering wheel angle ratio.

2. The method of claim 1, wherein the second sensor data comprises first image data received from a front view image sensor, second image data received from a left side view image sensor, third image data received from a right side view image sensor, and fourth image data received from a rear view sensor.

3. The method of claim 1, wherein the second sensor data comprises detected locations of one or more road features and the database data comprises known locations of the one or more road features.

4. The method of claim 3, wherein generating the vehicle movement model comprises comparing the second sensor data with database data to determine a position of the vehicle relative to the one or more road features.

5. The method of claim 4, wherein generating the vehicle movement model comprises correlating the detected locations of the one or more road features with the known locations of the one or more road features to determine the longitudinal and lateral distance traveled by the vehicle and generating a position change map of the vehicle.

6. The method of claim 5, wherein determining the lateral vehicle velocity and the longitudinal vehicle velocity along a vehicle path of travel comprises calculating the lateral vehicle velocity and the longitudinal vehicle velocity from the longitudinal and lateral distance traveled by the vehicle generated by the vehicle movement model over a predetermined elapsed time.

7. The method of claim 6, wherein defining the road wheel angle based at least in part on the lateral and longitudinal velocities of the vehicle comprises receiving the first sensor data at a first data recording frequency and receiving the second sensor data at the first data recording frequency and calculating the road wheel angle using the equation
$${δ}_{f} = {tan}^{- 1} ( \frac{{V}_{y} \cdot L}{{V}_{x} \cdot b} )$$
where the road wheel angle is expressed as δ_{f}, L is a wheel base of the vehicle, b is a distance from a center of gravity of the vehicle to a rear tire contact point, Vₓ is the longitudinal velocity of the vehicle, and V_{y} is the lateral velocity of the vehicle.

8. A method for modeling steering characteristics of a vehicle, comprising:
determining, by one or more data processors, whether a first condition is satisfied;
receiving, by the one or more data processors, first sensor data corresponding to a steering wheel angle from at least one vehicle sensor;
receiving, by the one or more data processors, second sensor data corresponding to image data of an external environment of the vehicle from at least one vehicle sensor;
if the first condition is satisfied, determining, by the one or more data processors, whether a second condition is satisfied;
if the second condition is satisfied, generating, by the one or more data processors, a vehicle movement model from the first and second sensor data;
determining, by the one or more data processors, a lateral vehicle velocity and a longitudinal vehicle velocity along a vehicle path of travel;
defining, by the one or more data processors, a road wheel angle based at least in part on the lateral and longitudinal velocities of the vehicle; and
determining, by the one or more data processors, a road wheel to steering wheel angle ratio using a plurality of polynomial curves to approximate the road wheel to steering wheel angle ratio.

9. The method of claim 8, wherein the first condition is whether the vehicle is moving.

10. The method of claim 9, wherein the second condition is whether a motion tracking feature of the vehicle is active.

11. The method of claim 8, wherein the second sensor data comprises detected locations of one or more road features and the database data comprises known locations of the one or more road features.

12. The method of claim 11, wherein generating the vehicle movement model comprises comparing the second sensor data with database data to determine a position of the vehicle relative to the one or more road features.

13. The method of claim 12, wherein generating the vehicle movement model comprises correlating the detected locations of the one or more road features with the known locations of the one or more road features to determine the longitudinal and lateral distance traveled by the vehicle and generating a position change map of the vehicle.

14. The method of claim 13, wherein determining the lateral vehicle velocity and the longitudinal vehicle velocity along a vehicle path of travel comprises calculating the lateral vehicle velocity and the longitudinal vehicle velocity from the longitudinal and lateral distance traveled by the vehicle generated by the vehicle movement model over a predetermined elapsed time.

15. The method of claim 14, wherein defining the road wheel angle based at least in part on the lateral and longitudinal velocities of the vehicle comprises receiving the first sensor data at a first data recording frequency and receiving the second sensor data at the first data recording frequency and calculating the road wheel angle using the equation
$${δ}_{f} = {tan}^{- 1} ( \frac{{V}_{y} \cdot L}{{V}_{x} \cdot b} )$$
where the road wheel angle is expressed as δ_{f}, L is a wheel base of the vehicle, b is a distance from a center of gravity of the vehicle to a rear tire contact point, Vₓ is the longitudinal velocity of the vehicle, and V_{y} is the lateral velocity of the vehicle.
